(19) United States
(12) Patent Application Publication
(10) Pub. No.: US 2022/0101272 A1
(43) Pub. Date: Mar. 31, 2022

(54) System and Method for Optimized Road Maintenance Planning

(71) Applicant: GoodRoads, Inc., Charlotte, NC (US)

(72) Inventors: Christopher Sunde, Charlotte, NC (US); Noel Shaji Varghese, Charlotte, NC (US); Deepshikha Purwar, Charlotte, NC (US); Kyle Raub, Charlotte, NC (US); Yakov Keselman, Charlotte, NC (US); Robert Mion, Charlotte, NC (US); Taha Arif, Raleigh, NC (US); Benjamin Gardner, Winston-Salem, NC (US); Abhilash Mandlekar, Charlotte, NC (US); Prabhakar Srinivasan, Tamil Nadu (IN)

(21) Appl. No.: 17/481,229

(22) Filed: Sep. 21, 2021

Related U.S. Application Data
(60) Provisional application No. 63/085,863, filed on Sep. 30, 2020.

(51) Int. Cl. G06Q 10/00; G06Q 10/04; G06K 9/00; G06T 7/00; G06N 20/00

(52) U.S. Cl. CPC G06Q 10/20; G06Q 10/04; G06K 9/00744; G06T 2207/20081; G06N 20/00; G06T 2207/10016; G06T 7/0004

(57) ABSTRACT

The present invention is a system and method for delivering optimized road maintenance analysis to a municipality. The instant innovation scans roadways for distressed street surfaces, damaged signage, and other less-than-optimal municipal assets. Data is collected by multiple municipal fleet vehicles as such vehicles drive upon roads within a municipality. Collected data are analyzed by a machine learning algorithm using criteria that most directly correspond to multi-year road quality predictions. The instant innovation provides to a user one or more suggestions and scenario results for roadway maintenance strategies based upon the data analysis.

### CLAIM OF PRIORITY

This Non-Provisional application claims under 35 U.S.C. § 120, the benefit of the Provisional Application 63/085,863, filed Sep. 30, 2020, Titled “System and Method for Optimized Road Maintenance Planning”, which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The ubiquity of modern automobiles demands that automobile thoroughfares receive timely and appropriate maintenance. Weather factors such as extreme heat and extreme cold, in combination with the wearing effects of precipitation, create conditions ripe for the steady deterioration of roads. In combination with high traffic volumes, roads can be expected to fail through cracking, heaving, and the formation of potholes.

Municipalities typically bear the responsibility to build and maintain roads and roadways, including accompanying signage. Road signage, whether static or dynamic, and whether composed of enameled metal or light emitting diode, is subject to many of the same weathering effects that limit the usable lifetime of roads. However, because signage is typically oriented well above ground level, it is subject to the additional threats of wind and vandalism. Indeed, any municipally-controlled assets that are subject to the vagaries of weather and vigorous public use (or misuse) require ongoing inventorying to ensure timely repair.

Most municipalities committed to ongoing maintenance utilize costly dedicated vehicles and human inspectors to traverse all roadways within their jurisdiction and manually record distresses and assign ratings to such distresses. Those human inspectors or their colleagues are thus tasked with using un-intuitive software programs to select assets for repair based in part upon such human-applied ratings. These laborious procedures are typically capable of being borne only by large municipalities with sizable budgets.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a sub-process for determining data biases consistent with certain embodiments of the present invention.

FIG. 2 is a view of a sub-process for removing data biases and processing a resulting data set consistent with certain embodiments of the present invention.

FIG. 3A is a view of a first analyzed photographic image relevant to street condition available to a user consistent with certain embodiments of the present invention.

FIG. 3B is a view of a second analyzed photographic image relevant to street condition available to a user consistent with certain embodiments of the present invention

FIG. 4A is a view of a third analyzed photographic image relevant to street condition available to a user consistent with certain embodiments of the present invention.

FIG. 4B is a view of an analyzed photographic image relevant to sign inventory available to a user consistent with certain embodiments of the present invention.

FIG. 5A is a view of a first web application user experience consistent with certain embodiments of the present invention.

FIG. 5B is a view of a second web application user experience consistent with certain embodiments of the present invention.

FIG. 6 is a view of a third web application user experience consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “device” refers to any electronic communication device with network access such as, but not limited to, a cell phone, smart phone, tablet, iPad, networked computer, internet computer, laptop, watch or any other device, including Internet of Things devices, a user may use to interact with one or more networks.

However, unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Because municipal road-maintenance budgets are finite, if such allotments exist at all, there is a need for a system and method for mechanically scanning roads and locating portions of roadways that appear rough, patchy or in need of repair. Such a system and method would capture and analyze at least photographic images to provide information that assists in the planning for road maintenance.

In an embodiment, the instant innovation collects data from a device having an integrated camera which is installed on multiple vehicles or may be carried manually. The integrated camera within each device is positioned for greatest advantage in viewing a road or sidewalk surface. In a non-limiting example, the device may be oriented such that the camera is forward-facing, and thus capable of capturing images in the direction of the vehicle's normal direction of travel. In additional non-limiting examples, the device may be oriented either facing backward from the direction of travel or to the side which may be perpendicular to the direction of travel of the vehicle such that the integrated camera may capture images behind or to the side of the vehicle. Such captured images may include, by way of non-limiting example, and may permit inventory from the same images:
Pavement markings
Street signs
Sidewalks
Curb
Gutter
Park benches
Utility poles
Street lights
Traffic signals
Bike racks
Trash cans
Bus stops
Manholes (in addition to being a valuable asset by themselves, these indicate the location of sewer pipes and storm drain pipes under the ground)
Storm drainage catch basins (indicate the location of storm drain pipes under the ground)
Water valves (these indicate the location of water pipes under the ground)
Junction boxes for power, telephone, fiber optic, and traffic signal lines (these indicate the rough location of these lines)
Gas valves (these indicate the location of underground gas pipes)
Temporary utility paint markings.

In a non-limiting embodiment, the system may train a machine-learning algorithm to identify each of these items, read them for those items that may contain text, and locate them.

Captured images may then be analyzed by a machine-learning algorithm utilizing criteria corresponding to standard road distresses, including, but not limited to fatigue cracking, block cracking, utility patches, longitudinal and transverse cracks, and potholes. Another machine-learning algorithm analyzes the road distress data and combines it with data that most affect road quality such as, by way of non-limiting example, maintenance type, traffic volume and flow, environmental factors, census data, and both current and prospective budget constraints. The system would then deliver planning criteria and information to a user for anticipated road maintenance for a multiple-year period from the image capture date.

In an embodiment, a dedicated device may directly collect or import from third-party roadway images, accelerometer data and Global Positioning Satellite (GPS) readings only when the vehicle conveying the device is in motion. Upon image collection, the device uploads photos of areas requiring inspection to a server. In an embodiment in which the device has captured images on multiple electronic drives, or in which the device has captured overexposed images or images of roadways that do not require inspection, or any other unwanted images, the device discards such unwanted images prior to upload. Using artificial intelligence, the system inspects all collected and/or imported photographs to locate and identify within the inspected photographs any specific road distresses as described in road maintenance reference materials such as, in non-limiting examples, governmental bulletin ASTM D6433-18, Long Term Pavement Preservation (LTPP) Program, the German inspection standard, or a customized inspection standard, as long as the reference incorporates the distresses for which inspection is desired. The device may then calculate the square footage of the road area that contains any such distresses.

In an embodiment, the instant innovation utilizes accelerometer data to identify specific road distresses based on the roughness pattern such distresses create in the collected accelerometer data. Such roughness pattern can be thought of as a “fingerprint” giving a user insight into the type and severity of road damage.

We can now measure International Roughness Index (IRI) from our accelerometer. The technique involves high-pass filtering the raw acceleration readings and double-integrating to arrive at a displacement, which can be aggregated over every 20′ or any given length to provide the International Roughness Index, expressed in vertical inches of displacement over a given length—usually 1 foot, or in meters of vertical displacement per kilometer.

The accelerometer may permit expressing displacement and roughness readings with any rating system a user may require, up to and including even individual distresses. Instead of an ASTM rating, the system may predict how much “fatigue cracking” will progress on a street using this same approach or how rough the ride may become as measured by the IRI, or other rating system as supplied by a user. A standard capability currently is to replace a stock aging curve with actual data measured using various technique. The system herein described permits the melding of a stock aging curve and actual measured data together to form a blended road aging curve to provide an optimized measurement for the aging of a road surface or road system.

The system and machine-learning method can also build family curves—for example providing a family of aging curves for roads in X climate and Y number of cars per day. Although this is not unknown in the industry the system herein described has created a novel model for generating these family curves with a very small amount of data. In a non-limiting example, a family of curves may be generated from as few as 20 records that don't cover the entire 20-year life of a road, yet provides an optimized set of road aging curves for various conditions and road use levels. The algorithm involves incrementally taking averages of roads whose aging curves overlap at 1 to 1.25 years of age, 1.25 to 1.5 years, and so on. Other models need a lot more data to build these curves, and, thus, often have to use a stock curve where the system and machine-learning method can often build unique curve models on smaller subsets of roads.

Data to be collected and imported may include records regarding construction costs, materials, techniques, contractors, geological samples taken during road design, traffic counts and other data to build a profile and history of roads in our customer cities. We can fuel our predictive analytics algorithms that artificially age and improve roads to create our 10-year model. So instead of a static aging curve, the aging curve is modified with dynamic data combined with one or more stock aging curves to create a dynamic, blended family of aging curves utilizing collected data.

The instant innovation uses data science to evaluate all collected data for the criteria that most affect road quality—including maintenance type, traffic, environmental factors, census data, and money spent to predict road aging and up to multiple years in the future. In an embodiment, the system is available to municipalities through a web application. The system provides a tool for cities to (1) model the effect of various road maintenance strategies, such as worst-first, and (2) given a maintenance strategy, the system may compute an optimal maintenance schedule multiple years into the future by treating it as a discrete optimization problem, such as knapsack.

In an embodiment, the device of the instant innovation is deployed by placing multiple devices on a network of vehicles or carried manually. Such vehicles need not be dedicated to road maintenance data collection. In a non-limiting example, the instant innovation may employ a network of devices mounted permanently, semi-permanently, or temporarily upon or within fleet vehicles such as but not limited to garbage trucks, recycling trucks, or street sweepers. Additionally, devices may be attached to other vehicles such as drones or other airworthy vehicles. The instant innovation will permit a municipality to assess and/or inventory factors such as, by way of non-liming example, road quality, utility patches, street signs, pavement markings, sidewalks, curbs, manholes, water valves, catch basins, park benches, household and city-owned trash cans, power lines and fleet vehicle movements. The device is a low-cost sensor platform that may include, by way of non-limiting example, a camera, an accelerometer, and a GPS tracker.

Additionally, data collection may be performed through the use of aerial assets such as drones, ultralight aircraft, or other air worthy vehicles, or such data may be provided by satellite imagery to inventory sidewalks, curbs, gutters, pavement markings, utility patches and other assets in addition to data on assets as described in the previous paragraph. Upon collection and receipt of data from aerial or satellite resources having sufficient visual resolution, the data may be stored and used by the machine learning algorithm to provide a more accurate, comprehensive, and optimized maintenance and replacement schedule for all types of roadway assets, such as pavement and pavement marking repair and replacement, and assets associated with a roadway such as street signs, pavement markings, sidewalks, curbs, manholes, water valves, catch basins, park benches, household and city-owned trash cans, power lines and fleet vehicle movements, as previously recited.

In an embodiment, the instant innovation may also incorporate the use of LIDAR in conjunction with or in lieu of a camera to collect roadway data. The instant innovation may incorporate air quality and/or sound sensors. A municipality can set criteria for inspection, including what to inspect for, using the web application. The municipality is then charged accordingly.

In an embodiment, the device of the instant innovation is hard-wired to a vehicle and has cell phone connectivity or is paired with a cell phone or similar device via a WiFi hotspot. The embodiment may include a server stationed at a fleet vehicle yard that would perform image processing and relay information back to a main cloud server.

In an embodiment the instant innovation may track municipal, transportation, and other pre-configured assets using devices installed in a fleet of non-dedicated vehicles, or carried manually by transportation workers, that are roaming roadways within a municipality. The instant innovation utilizes artificial intelligence to analyze data collected by such devices to identify specific distress types represented by the data. The specific distress types, regardless of data source, may be thought of as a distress “fingerprint.” The instant innovation uses forward-facing image data to measure distressed square footage represented by a forward-facing image. In a non-limiting example, the device may be calibrated for square footage calculations of identified distressed areas based on known landmarks such as manholes, water valves, road striping or other features of known dimensions with regard to length and width or pre-configured area. With a sufficient quantity of images containing these landmarks at different locations in the image, where a sufficient quantity of images may be between 5 and 20 or more, at the given device placement and orientation, the system may empirically equate pixel counts at different locations in an image to the known square footage of the landmark. From this calculation the system may also derive an equation to represent the different conversion ratios at different depths in the perspective view of images captured by the image capture devices. Using either the derived equation, the empirical ratios, or a hybrid combination of the two, a device capable of image capture may be placed in any orientation and angle on any vehicle and the calibration module of the system ensures accurate pixel-to-square footage conversions regardless of depth or location in the image.

In an embodiment, the instant innovation's aggregation of data around road quality, maintenance, safety, and past quality history is utilized to find trends and best practices in road maintenance. The instant innovation returns one or more results of road maintenance choices to a user based upon data analysis of road maintenance scenarios input by the user. The results supplied by the system permit the user to optimize maintenance plans for roadways, municipal assets, transportation assets, and other pre-configured assets.

The system and platform herein described is designed to be a rapid feedback loop for reporting on road aging and optimize response and repair based upon the more rapid, as compared to systems currently in place, feedback and analysis from collected and calculated road condition data. Instead of no feedback or 5-10 year feedback, the data collection effort for the platform is offered as annual feedback on how a city is progressing. To accomplish this feedback optimization, the data collection by the system and platform occurs on an annual basis. However, an additional aspect of the system and platform that may improve both recognition of road issues and spur efforts at repair and improvement is that the system and platform may insert critical information at specific decision points. In a non-limiting example, vehicles may be deployed to drive the streets that a city has advertised in a Street Resurfacing contractor on which general paving contractors may place bids. The measurement and data collection capabilities of the system may measure and inventory the cracks and other road surface conditions to ensure that contractor bids submitted to the city are accurate. Additionally, the system can predict locations that may require change-orders that are unforeseen by humans. In this non-limiting example, many times, a street is milled by a contractor and after milling but before resurfacing, the city or DOT staff will identify areas of full-depth asphalt replacement rather than just resurfacing. This can often present a loss to a contractor or a cost increase for a city. The system may provide an overlay of areas of prior cracking and areas that required complete replacement to identify signs of this change in work prior to construction, saving the contractor and city time and money. In this manner, when a street maintenance plan is created for the next 10 years, the system is active to match up other data sources like traffic accidents, real estate developments, known utility failures, and census data that may affect the priority or even decision to repair a particular roadway prior to the issuance of a request for proposal for street re-surfacing activity.

In a non-limiting example, the system may utilize information from traffic accidents as data elements to consider then prioritizing which roads require maintenance. In this non-limiting example, the system may inform the city Public Works director for a city that of the 100 streets that are in the most recent plan to maintain, 5 of them have known speeding problems or pedestrian/bike accidents. The corrective action for these kinds of issues can be addressed by painting in bike lanes or narrowing traffic lanes or high visibility crosswalks or something more substantial as part of the paving project, often with minimal added cost as they are included in the pre-planning effort.

In another non-limiting example, the system may utilize information from utility repair activities as data elements for planning and can instantly inform the Public Works director at a customer city that $300 k, for example, in utility repairs are at risk. Meaning there have been 5+ utility failures that caused cutting up the street on these 18 streets. At the request of the user the system will inform the specific utility companies that those streets will be paved in X year and the utility has until then to plan a full replacement of their pipes on those streets prior to construction or risk having to replace the entire street at cost if there is another failure that causes cutting up the street in the 3 years after the streets department repaves that road. Automating this element of the planning process for road maintenance lowers cost and liability for the city, as well as optimizes the coordination of effort to maintain and upgrade city utilities and roadways.

In another non-limiting example, the system may utilize information from Real estate developers to permit the city to check which planned streets will be adjacent to current real estate developments. Often cities will repave something that the developer should be “conditioned”/required to repave since their construction is responsible for tearing up the street or the new traffic that development will bring will tear up the street faster. Commonly, city street maintenance departments don't adequately talk with the Development Services department to make the connection that the real estate developer should be responsible for repairing and/or repaving the roadway, and therefore pave the road anyway. The system and platform may connect that dot for cities and notify the right people in the city and at the developer that the developer either needs to do the paving or pay the city for its work.

In another non-limiting example, the system may utilize Census data to optimize future road maintenance and planning. The system may provide cities insight into how equitable they are with their road paving plans. Are city planning departments or other decision makers treating different areas of town with different ethnic makeups and different median household incomes with equal or even equitable road quality. The system may provide decision makers with information on absolute road quality without regard to outside criteria.

In another non-limiting example, the system may utilize information on local economic development to assist a planning department to recognize future areas of concern and optimize planning for roadways in such areas. Often, if a city wants to revitalize a certain area, they will invest in a park, wider sidewalks, better crosswalks, park benches, street trees, bike lanes, and also giving businesses funding or helping them fix up the fronts of their shops. This almost always involves keeping the streets repaved. Information from the system permits a city to select specific areas or groups of roads on which to focus. Such information is inclusive of economic, tax or other data to help a city measure the efforts of such projects.

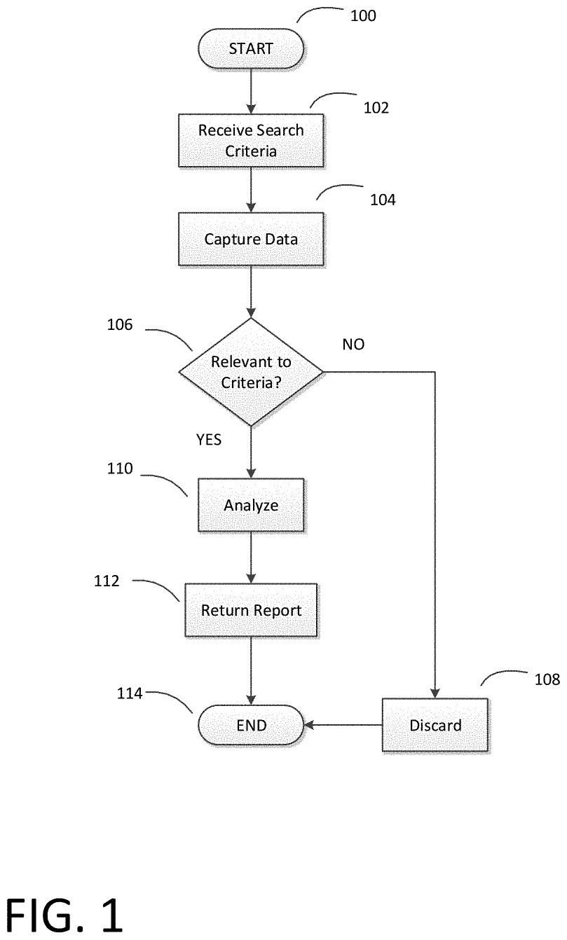

Turning now to FIG. 1, a view of the process for capturing data and providing reports thereon consistent with certain embodiments of the present invention is shown. At 100 the process starts. At 102 the system receives search criteria from a user. In an embodiment such search criteria would reflect the parameters for which analyzed data is sought by the user. By way of non-limiting example, such search criteria may include asset inventory or asset condition, particular asset type, and geographic or temporal asset bounds. At 104, the system captures data appropriate for analysis of the user-specified asset type. In an embodiment, data may take the form of photographic images or accelerometer data tagged with corresponding GPS coordinates. In the non-limiting example of the system capture of photographic images, a forward-facing camera may be mounted on or in a non-dedicated vehicle, or may be carried manually by a worker traversing a roadway or sidewalk. The camera may be triggered to begin filming roadways by forward vehicle motion. The camera then may capture images of the road surface and the areas immediately adjacent and above the roadway, including curbs, sidewalks, signage, and power lines, as applicable. At 106 the system makes an initial determination as to whether any captured image is relevant to the user-provided search criteria. At this stage, duplicate or unusable images (such as blurred, out of focus, or similarly technically unsatisfactory images), or images captured erroneously or outside of user-provided geographic or temporal bounds may be discarded at 108. For images discarded at 108, the system ends at 114. If at 106 the captured data is determined to be relevant to the user-defined search criteria, at 110 the data is sent to a central server for analysis utilizing and artificial intelligence algorithm. Such analysis uses elements of the user-defined search criteria in concert with a machine-learning algorithm, to determine asset types and conditions and to perform an analysis of returnable data relevant to the user's end goals. For instance, by way of non-limiting example, captured image data showing street conditions may be subject to analysis by the machine-learning algorithm to determine the existence and type of physical distress, including, in non-limiting examples, gross transverse cracks or more delicate and systemic alligator cracking among other types of distress or road conditions requiring analysis and repair. The machine-learning algorithm may then measure the road surface area characterized by such distress. At 112 the system returns a report tailored to the user-defined end goals. In an embodiment, the system report may include asset verification and GPS location, confirmation of damage and type of distress, the extent of any such distress, and a calculated estimate of the current cost to repair such distress. Upon delivery of a report, the process ends at 114.

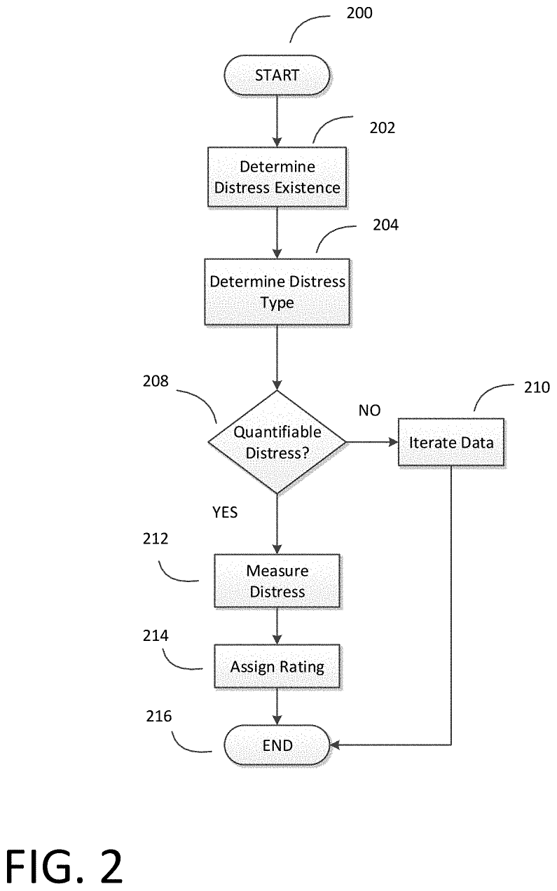

Turning now to FIG. 2, a view of a sub-process for captured relevant data analysis consistent with certain embodiments of the present invention is shown. At 200 the sub-process starts. At 202 the system determines the existence of any identified distress of interest to the user. For instance, by way of non-limiting example, the system may determine that the captured data shows indicia that suggest the presence of street surface cracking. At 204 the system determines the type of distress through analysis of captured data by one or more machine-learning algorithms, such as transverse or alligator cracking. If at 208 the system determines that the distress does not meet the minimum algorithmic criteria to be considered quantifiable, at 210 the system iterates to analyze the next input data, and the sub-process ends at 216. If at 208 the system determines that the distress does meet the minimum algorithmic criteria to be considered quantifiable, at 212 the system measures the distress. For instance, by way of non-limiting example, the system would determine the area of street surface distress characterized by alligator cracking. At 214 the system assigns a rating to the distress based upon the severity of the distress and the nature of the asset. At 216 the sub-process ends.

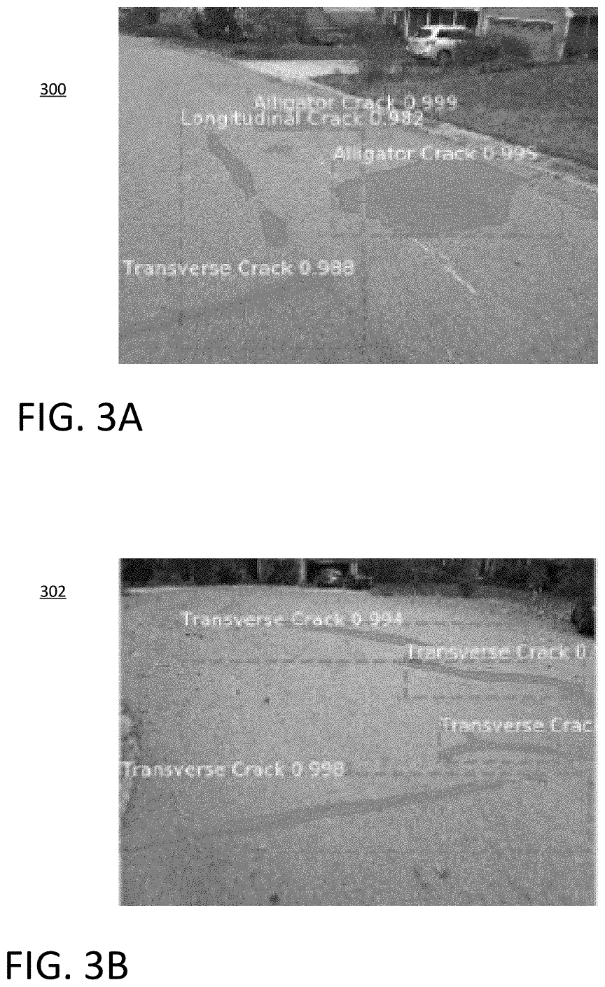

Turning now to FIG. 3A, a view of a first analyzed photographic image relevant to street condition available to a user consistent with certain embodiments of the present invention is shown. At 300 the system has determined the presence of and assigned values to at least longitudinal, transverse, and alligator cracks present in a road surface corresponding to user-provided criteria, and has superimposed indicia of such determination upon the image.

Turning now to FIG. 3B, a view of a second analyzed photographic image relevant to street condition available to a user consistent with certain embodiments of the present invention is shown. At 302 the system has determined the presence of and assigned values to at least four transverse cracks present in a road surface corresponding to user-provided criteria, and has superimposed at least partial indicia of such determination upon the image.

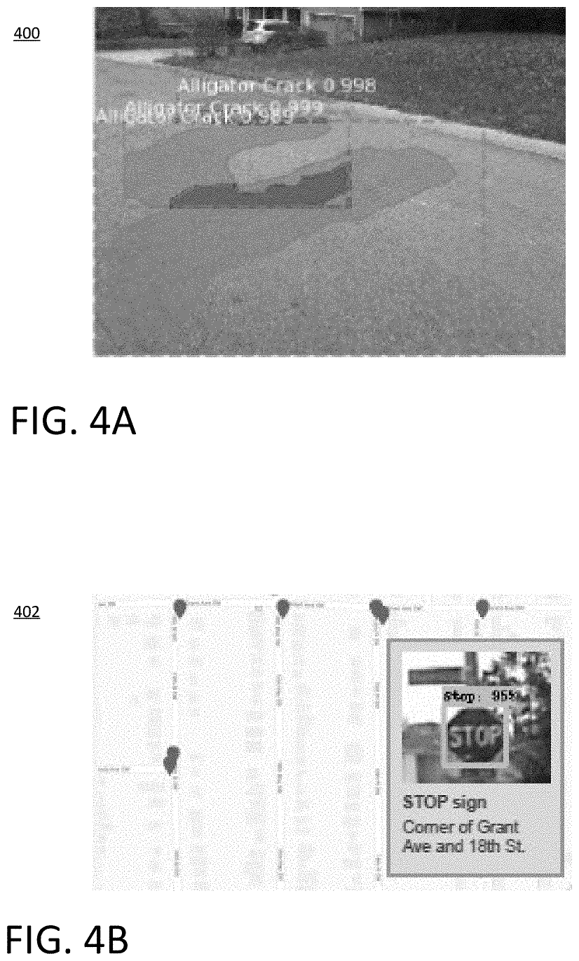

Turning now to FIG. 4A, a view of a third analyzed photographic image relevant to street condition available to a user consistent with certain embodiments of the present invention is shown. At 400 the system has determined the presence of and assigned values to at least three alligator cracks present in a road surface corresponding to user-provided criteria, and has superimposed indicia of such determination upon the image.

Turning now to FIG. 4B, a view of an analyzed photographic image relevant to sign inventory available to a user consistent with certain embodiments of the present invention is shown. At 402 the system has determined the presence and type of signage, assigned values to at least the accuracy of determination, and superimposed indicia of such determination upon the image. The delivered asset image is shown oriented to its position in the real world by its juxtaposition to map data.

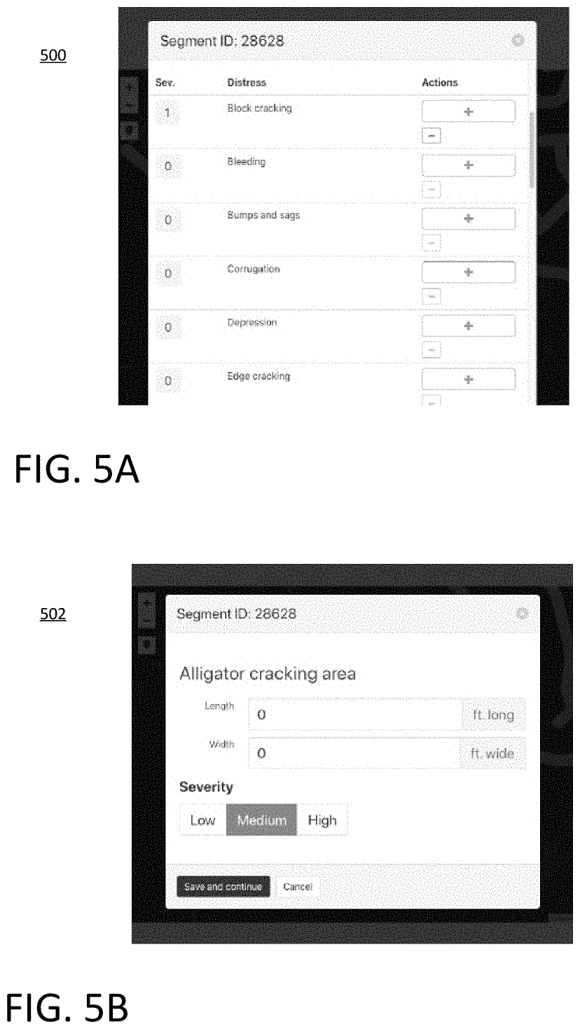

Turning now to FIG. 5A, a view of a first web application user experience consistent with certain embodiments of the present invention is shown. At 500 the system has returned to the user a menu for Segment ID 28628 reflecting the presence of Block Cracking and enabling the user to determine subsequent action.

Turning now to FIG. 5B, a view of a second web application user experience consistent with certain embodiments of the present invention is shown. At 502 the system has returned to the user a menu for Segment ID 28628 reflecting the absence of Alligator Cracking and enabling the user to determine subsequent action.

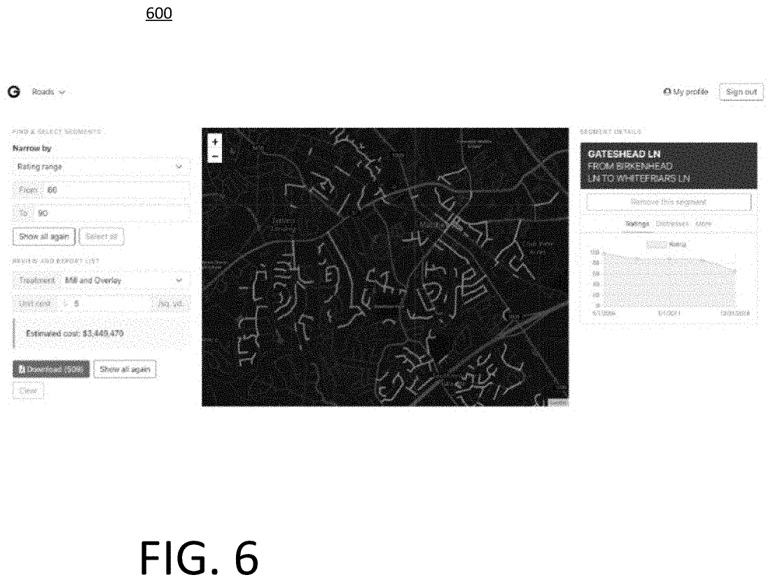

Turning now to FIG. 6, a view of a third web application user experience consistent with certain embodiments of the present invention is shown. At 600 the system has returned to the user a dashboard showing a map of the geographical location of surveyed assets, a description of determined asset ratings, and an estimate of repair costs associated with distressed assets.

While certain illustrative embodiments have been described, it is evident that many alternatives, modifications, permutations and variations will become apparent to those skilled in the art in light of the foregoing description.

I claim:

1. A method for delivering optimized road maintenance analysis comprising:
collecting a data set of video images of roadway condition indicia;
providing said video images to a machine learning algorithm, where said machine learning algorithm labels each video image with an initial indicator of an area or item of concern;
providing said video images and said machine learning algorithm supplied labels to a human evaluator;
determining accuracy of said machine learning algorithm supplied labels and relevance of the indicia to user criteria;
for all accurate machine learning algorithm supplied labels and relevant indicia, said machine learning algorithm analyzing relevant indicia for quantifiable distress, to measure the quantifiable distress and to assign a rating thereto;
providing optimization analysis to a user based at least in part on said rating and user criteria;
said user utilizing recommendations and information from said optimization analysis to plan and execute road maintenance activities.

2. The method of claim 1, where the data set of roadway condition indicia is captured dynamically in raw video images and accelerometer data.

3. The method of claim 1, where said machine learning algorithm labels are identified by said human evaluators as accurate, a false positive, a negative result, or a false negative as identified in said user criteria.

4. The method of claim 1, where the human evaluator relabels images where the human evaluator determines that false positives or false negatives have been applied by said machine learning algorithm.

5. The method of claim 1, where the machine learning algorithm is hosted on a central server.

6. The method of claim 1, where the roadway condition indicia are determined to be quantifiable roadway distress that is expressed as road surface damage.

7. The method of claim 6, where the quantifiable distress is expressed as signage type and location.

8. The method of claim 1, further comprising expressing quantifiable roadway distress to provide a measure of the distress according to an International Roughness Index and expressed in vertical inches of displacement over a given length of roadway.

9. The method of claim 1, further comprising artificially aging and/or improving one or more roadway surfaces utilizing a predictive analytics algorithm.

10. The method of claim 9, where said predictive analytics algorithm combines stock aging curve data with actual roadway condition indicia data to create a family of customized roadway aging curves utilizing fewer data points to create an optimized customized roadway aging curves.

11. A system for optimization of roadway maintenance, comprising:
a server comprising at least one data processor;
said server collecting a data set of video images of roadway condition indicia from at least one video image capture device and at least one accelerometer;
said server providing said video images to a machine learning algorithm, where said machine learning algorithm labels each video image with an initial indicator of an area or item of concern;
said server providing said video images and said machine learning algorithm supplied labels to a human evaluator;
said server determining accuracy of said machine learning algorithm supplied labels and relevance of the indicia to pre-established user criteria;
within said server, for all accurate machine learning algorithm supplied labels and relevant indicia, said machine learning algorithm analyzing relevant indicia for quantifiable distress, to measure the quantifiable distress and to assign a rating thereto;
said server providing optimization analysis to a user based at least in part on said rating and user criteria;
communicating recommendations to a user, and said user utilizing recommendations and information from said optimization analysis to plan and execute road maintenance activities.

12. The method of claim 11, where the data set of roadway condition indicia is captured dynamically in raw video images and accelerometer data utilizing said at least one image capture device and said at least one accelerometer.

13. The method of claim 11, where said machine learning algorithm labels are identified by said human evaluators as accurate, a false positive, a negative result, or a false negative as identified in said user criteria.

14. The method of claim 11, where the human evaluator relabels images where the human evaluator determines that false positives or false negatives have been applied by said machine learning algorithm.

15. The method of claim 11, where the machine learning algorithm is hosted on a central server.

16. The method of claim 11, where the roadway condition indicia are determined to be quantifiable roadway distress that is expressed as road surface damage.

17. The method of claim 16, where the quantifiable distress is expressed as signage type and location.

18. The method of claim 11, further comprising expressing quantifiable roadway distress to provide a measure of the distress according to an International Roughness Index and expressed in vertical inches of displacement over a given length of roadway.

19. The method of claim 11, further comprising artificially aging and/or improving one or more roadway surfaces utilizing a predictive analytics algorithm.

20. The method of claim 19, where said predictive analytics algorithm combines stock aging curve data with actual roadway condition indicia data to create a family of customized roadway aging curves utilizing fewer data points to create an optimized customized roadway aging curves.
